(19) United States
(12) Patent Application Publication
(10) Pub. No.: US 2009/0117411 A1
(43) Pub. Date: May 7, 2009

(54) MAGNETIC DISK SUBSTRATE AND MAGNETIC DISK THEREOF

(75) Inventors: Hiroyuki Machida, Ichihara-shi (JP); Katsuaki Aida, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., MINATO-KU, TOKYO (JP)

(21) Appl. No.: 12/094,343

(22) PCT Filed: Dec. 13, 2006
(86) PCT No.: PCT/JP2006/325310

§ 371 Date: May 20, 2008

Related U.S. Application Data
(60) Provisional application No. 60/753,418, filed on Dec. 27, 2005.

(30) Foreign Application Priority Data
Dec. 19, 2005 (JP) 2005-364545

(51) Int. Cl. G11B 5/62

(52) U.S. Cl. 428/846.1

(57) ABSTRACT

The object of present invention is to provide a magnetic disk substrate which uses a silicon substrate, in which chamfered surfaces are provided between the main surfaces of the silicon substrate and the outer circumferential surface; a ski-jump value H₀ where H₀≦0 μm, representing the distance from the basal level to point A₃; a roll-off value H₁ where H₁≧−0.2 μm and H₁≦0.0 μm, representing the distance from the basal level to point A₁; a tag-off value H₂ where H₂≧0 μm and H₂≦0.012 μm, representing the maximum displacement of the border line of the main surface with respect to the line A₁ to A₂; curved surfaces are provided between the main surfaces and the chamfered surfaces; and the curvature radius R of the curved surface where R≧0.013 mm and R≦0.080 mm.

This application claims the priority of Japanese Patent Application No. 2005-364545, filed Dec. 19, 2005, and the priority benefit of U.S. Provisional Application No. 60/753,418, filed on Dec. 27, 2005, the contents of which are incorporated herein by reference.

### TECHNICAL FIELD

The present invention relates to a magnetic disk substrate formed by using a silicon substrate, and a magnetic disk utilizing this magnetic disk substrate.

### BACKGROUND ART

In recent years, the storage capacity of a magnetic recording medium continues to increase as all sorts of IT products are developed. In particular, with regard to a magnetic disk apparatus such as a hard disk drive (HDD) which plays an important role as an external storage apparatus for a computer, its recording capacity and its recording density continue to increase from year to year. This is why a development of a magnetic disk which can record in a much higher density has been expected. On the other hand, a small and shock-proof magnetic disk apparatus is preferred in a portable electronic device such as a notebook computer. Recently, small magnetic disk apparatuses have also been applied to navigation systems, portable music players, and the like. Therefore, a microminiature magnetic disk has been expected, which enables recording in a much higher density and has excellent mechanical strength.

Consequently, in a magnetic disk substrate used for such a magnetic disk, the requirement of a much higher recording density has been emphasized as well as the requirement of slimming accompanied by miniaturization and weight saving, and mechanical properties such as rigidity which is required to be able to resist the surges of the disk when it rotates at a high speed. Also, in order to achieve such high recording density, the flying height of the magnetic head with respect to the magnetic disk has been drastically reduced. Therefore, it is required that the magnetic disk substrate have excellent flatness such as that of a mirror surface, have smooth surface, and have as few as possible defects on the surface such as fine scratches, fine pits, and fine projections.

Aluminum alloy substrates, glass substrates, and the like have been conventionally applied to the magnetic disk substrate. The aluminum alloy substrates are inferior in abrasion resistance and processability, and this is why aluminum alloy substrates whose surfaces are NiP-plated are used to compensate the demerits. However, there are demerits in the NiP-plated substrates, in which, for example, they are likely to be warped, and tend to be magnetized when they are treated at high temperatures. On the other hand, there are demerits in the glass substrates in which a layer of distortion is likely to generate on their surfaces when they are treated for reinforcement, and they are warped due to the effect of compression stress when they are heated.

In microminiature magnetic disks such as those having a diameter of 1 inch (27.4 mm φ) or 0.85 inches (21.6 mm φ), a demerit in which the substrate is warped, is fatal when they are applied to much higher-density recording. Therefore, a material which is much thinner and difficult to distort due to external forces, whose surface is smooth, and on which it is easy to form a magnetic recording layer has been expected as a substrate for such microminiature magnetic disks.

It has been proposed that silicon substrates, used frequently in the field of semiconductor engineering, be used as a magnetic substrate which complies with the above-described demands (for example, see Patent Documents 1 to 3). Such magnetic disk substrates using silicon substrates make it possible to form clean surfaces such that they have excellent flatness (i.e. like that of a mirror surface) have less surface-roughness, and have less defects on the surface such as fine scratches, fine pits, or fine projections. In addition to this feature, the silicon substrate has advantages. For example, its density is smaller than that of the aluminum substrate, its Young's modulus is larger, its coefficient of thermal expansion is smaller, its high-temperature properties are superior, and it has electric conductivity. Therefore, the silicon substrate is suitable for magnetic disks, and also, a durable magnetic disk substrate for magnetic disks can be provided by making the diameter of the disk smaller because the smaller the diameter of the disk, the smaller received impact force becomes.

When a silicon substrate for magnetic disks is produced, a single-crystal silicon ingot is generally produced in advance. Then, the single-crystal silicon ingot is processed into slices having a predetermined thickness. The silicon substrates having small diameters which are cut from the above slice-processed circular disk are subjected to a lapping process, a polishing process, or the like with respect to both sides of their main surfaces, and their outer circumferential surfaces, and they are mirror-finished.

However, the silicon substrates have a demerit in which they are likely to crack or break off through the above-described processes because they are materially fragile. If they have cracks or chips, not only the yield in producing the magnetic disk declines, but also the generated particles may cause an error or head crash when recording or writing.

In order to obtain a magnetic disk substrate having no cracks or chips in the silicon substrate, Patent Document 1 proposes a method in which the edges of the central aperture and the outer circumferential portion of the silicon substrate are chamfered with a grinding stone or the like, and the angles of the chamfered portions are rounded off. On the other hand, Patent Document 2 proposes a method in which chamfered surfaces of a circular arc are formed in a silicon substrate by way of chemical-etching. In addition, Patent Document 3 proposes a method in which the angle of chamfer in a silicon substrate is made to be from 20° to 24°, and the length of the chamfered portion is set from 0.03 mm to 0.15 mm. These patent documents 1 to 3 describe that their outer circumferential portions are processed into the above-described shapes, such that they can decrease cracks or chips made by handling or being dropped off in the producing processes, and their yield rate can be significantly improved.

Patent Document 1: Japanese Unexamined Patent Application, Publication No. H6-76282

Patent Document 2: Japanese Unexamined Patent Application, Publication No. H6-195707

Patent Document 3: Japanese Unexamined Patent Application, Publication No. H7-249223

### DISCLOSURE OF INVENTION

When a magnetic disk is produced, a primary coat, a magnetic recording layer, a protective layer, or the like are formed successively on the above-described substrate in order. Also, if micro-particles are present on the surface of the protective layer, the “burnishing treatment” is conducted thereon. In this burnishing treatment, the surface of the protective layer is lightly polished, for example, by pressing a moving lapping tape on the surface of the protective layer with a contact wheel made of rubber. By way of this treatment, the micro-particles present on the surface of the protective layer can be removed, and the floating rate of the magnetic head can be made much smaller.

However, when the lapping tape scrapes against the outer circumferential portion of the silicon substrate in the above-described burnishing process, particle dust is likely to generate from this lapping tape, and the generated particles will possibly remain on the surface of the magnetic disks. Then, the particles adhering to the surface of the magnetic disk will cause an error or head crash when reading or writing, so such magnetic disks having particles thereon are excluded in the final quality inspection.

The present invention was achieved in order to solve the above-described problem. The object of the present invention is to provide a magnetic disk substrate which can improve the yield in the magnetic disk production using silicon substrates, prevent errors or head crashes when reading or writing, and achieve much lower flying height of the magnetic head, so it can be compatible with much higher recording densification. Also, the object of the present invention is to provide a magnetic disk utilizing the same.

The present inventors studied the above-described problems, and discovered that it is necessary not only to prevent the silicon substrate, which is materially fragile, from cracking or chipping, but also to prevent the generation of the dusts thereon in the producing process of the magnetic disks by controlling the shape of the circumferential portion of this silicon substrate. This is such that the yield in magnetic disk production using silicon substrates can be improved, an error or head crash when reading or writing can be prevented, and a much lower magnetic head flying height can be achieved, so it can be compatible with a much higher recording density. Finally, this discovery resulted in the present invention.

That is, the present invention provides the following means.

(1) A magnetic disk substrate which uses a silicon substrate in which chamfered surfaces are provided between the main surfaces and the outer circumferential surface of the silicon substrate; a ski-jump value H₀ where H₀≦0 μm, representing the distance from the basal level to point A₃; a roll-off value H₁ where H₁≧−0.2 μm and H₁≦0.0 μm, representing the distance from the basal level to point A₁; a tag-off value H₂ where H₂≧0 μm and H₂≦0.012 μm, representing the maximum displacement of the border line of the main surface with respect to the line A₁ to A₂; curved surfaces are provided between the main surfaces and the chamfered surfaces; and the curvature radius R of the curved surface where R≧0.013 mm and R≦0.080 mm, where the basal level refers to a flat surface of the main surface; point A₁ refers to the position present on the border line of the main surface, which is located at the point displaced by 1 mm in the direction from the outer circumferential surface to the center of the substrate parallel to the basal level; point A₂ refers to the position present on the border line of the main surface, which is located at the point displaced by 1.6 mm in the direction from point A₁ to the center of the substrate parallel to the basal level; and point A₃ refers to the position present on the border line of the main surface between points A₁ and A₂, which is located at the highest position with respect to the basal level.
(2) The magnetic disk substrate according to (1), in which the roll-off value H₁ is H₁≧−0.18 μm and H₁≦−0.08 μm, the tag-off value H₂ is H₂≧0.004 μm and H₂≦0.008 μm, and the curvature radius R is R≧0.030 mm and R≦0.070 mm.
(3) A magnetic disk which uses the magnetic disk substrate according to (1) or (2).

According to the present invention, by processing the outer circumferential portion of the silicon substrate into the above-defined shape, not only the cracks or chips of the silicon substrate, which is materially fragile, can be prevented, but also the generation of the dusts thereon in the production process of the magnetic disks can be prevented. Consequently, particles of dusts or the like can be prevented from adhering to the surface of the magnetic disk, the production yield of the magnetic disk can be improved, the occurrence of errors or head crashes can be prevented when reading or writing, and it is possible for the magnetic head to fly thereover at a much lower height. Then, this makes it possible for the magnetic disk to be compatible with a much higher recording-densification.

### BRIEF DESCRIPTION OF THE DRAWINGS

FIG. 1A is a perspective view showing a cross-section of a silicon substrate.

FIG. 1B is a cross-sectional view of the silicon substrate.

FIG. 2 is an end view showing the cross-section of the silicon substrate.

FIG. 3 is a schematic diagram describing the basal level T, the ski-jump value V₀, and the roll-off value H₁.

FIG. 4 is a schematic diagram describing the tag-off value H₂.

FIG. 5 is a schematic diagram describing the curvature radius R of the curved surface.

FIG. 6 is a side view showing principal parts of a layer-built structure.

FIG. 7 is a perspective view showing the situation in which the inner circumferential portion of the layer-built structure is polished with a polishing brush.

FIG. 8 is a perspective view showing the situation in which the outer circumferential portion of the silicon substrate is polished with a polishing brush.

FIG. 9 is a cross-sectional view showing a layered structure in one example of the magnetic disk according to the present invention.

### BEST MODE FOR CARRYING OUT THE INVENTION

Hereinafter, the magnetic disk substrate and magnetic disk thereof according to the present invention will be described in detail by using figures. It should be understood that some parts featured in the present invention are enlarged in the figures for the purpose of explicitly describing their features, and their scale ratios or the like do not always reflect actual ratios. In addition, surface-profiling for setting the defined points can be achieved by using a commercially available surface-profiler, and a “CONTRACER CP400”, produced by MITSUTOYO CORPORATION is used for surface-profiling in the present invention.

### (Magnetic Disk Substrate)

First, the magnetic disk substrate of the present invention is described.

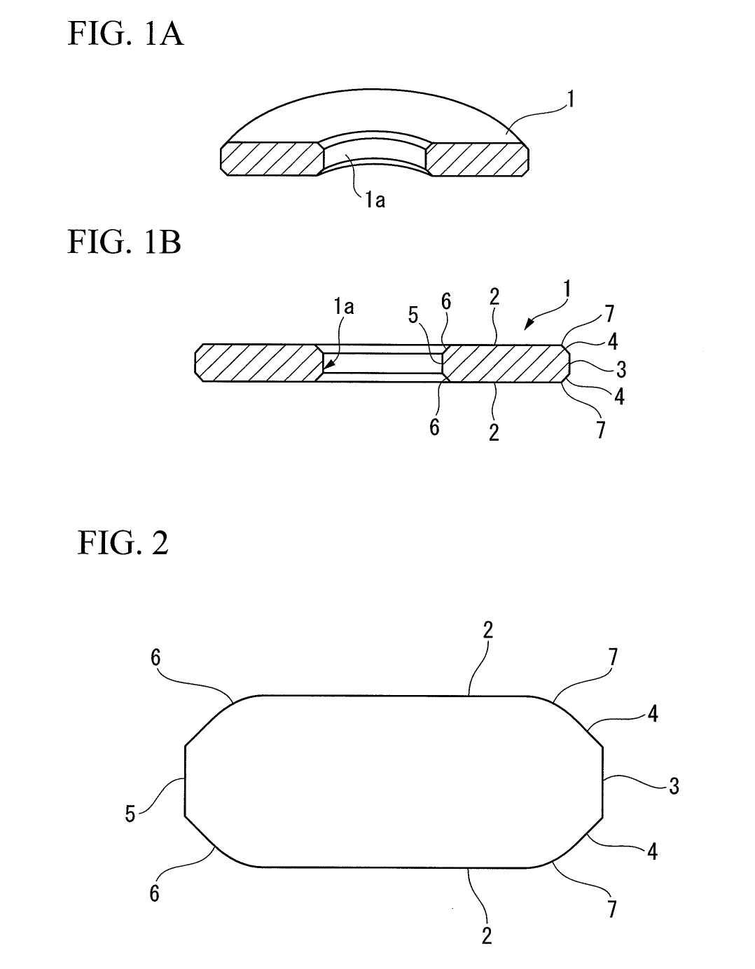

In FIG. 1 and FIG. 2, a magnetic disk substrate using a silicon substrate 1 of the present invention is shown. FIG. 1A is a perspective view showing a cross-section of the silicon substrate 1. FIG. 1B is a cross-sectional view of the silicon substrate 1. FIG. 2 is an end view showing the cross-section of the silicon substrate 1.

As shown in FIG. 1 and FIG. 2, the magnetic disk substrate of the present invention is formed with the silicon substrate 1 which is disk-shaped, and has a central aperture 1a. Also, chamfered surfaces 4 are provided between main surfaces 2 and an outer circumferential surface 3 of the silicon substrate 1. Also, chamfered surfaces 6 are provided between the main surfaces 2 and an inner circumferential surface 5 in the same way.

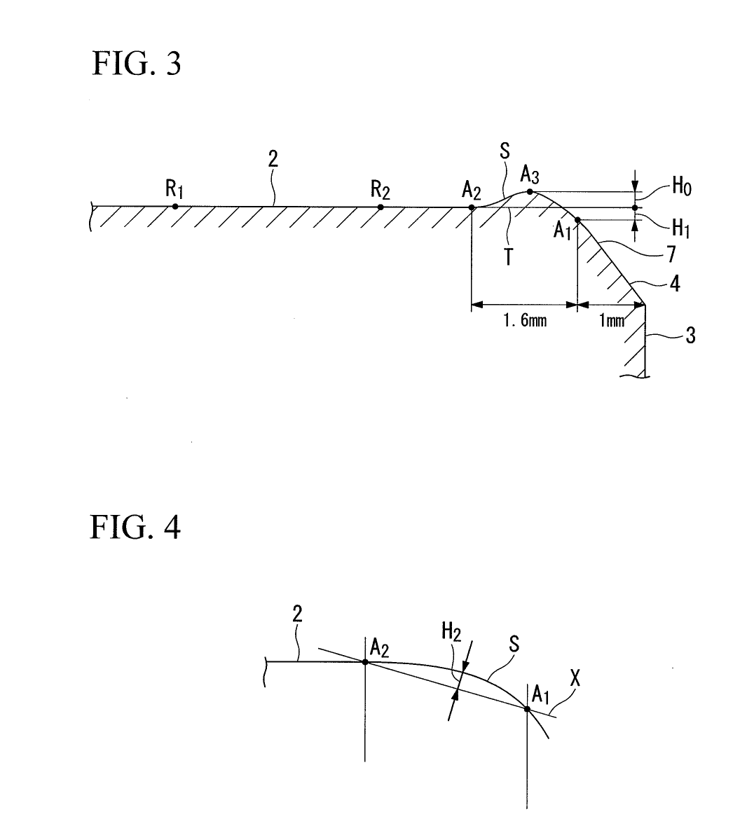

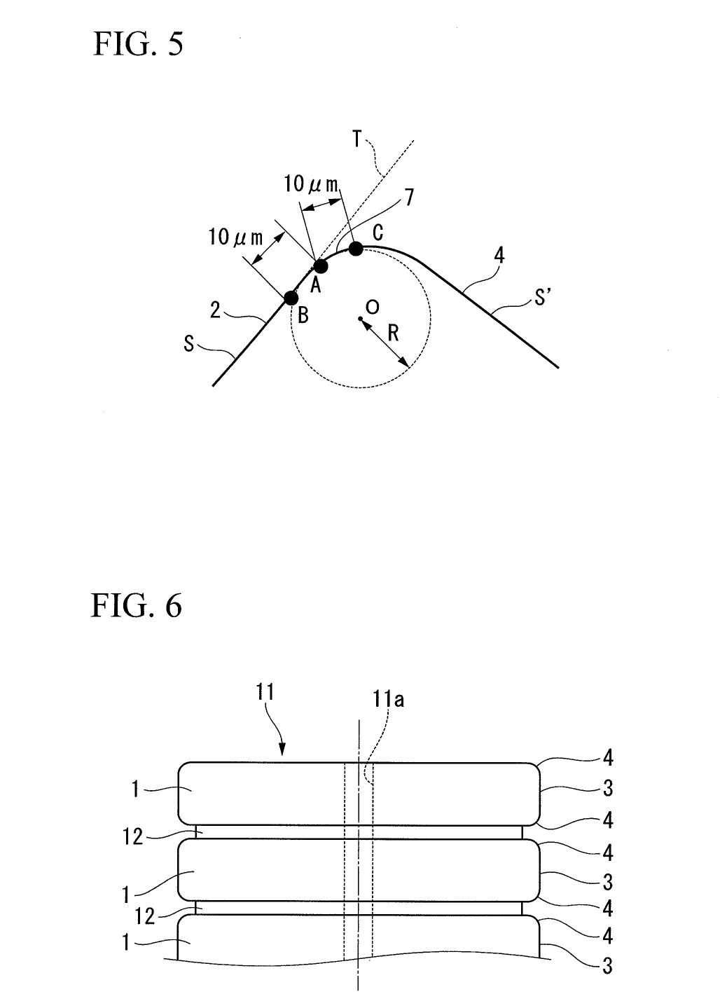

FIG. 3 is a schematic diagram describing the basal level T, the ski-jump value H₀, and the roll-off value H₁. FIG. 4 is a schematic diagram describing the tag-off value H₂. FIG. 5 is a schematic diagram describing the curvature radius R of the curved surface 7.

As described in FIG. 3 to FIG. 5, in the magnetic disk substrate of the present invention, the ski-jump value H₀ where H₀≦0 μm, representing the distance from the basal level T to point A₃; the roll-off value H₁ where H₁≧−0.2 μm and H₁≦0.0 μm, representing the distance from the basal level T to point A₁; the tag-off value H₂ where H₂≧0 μm and H₂≦0.012 μm, representing the maximum displacement of the border line S of the main surface 2 with respect to the line X which passes through points A₁ to A₂; a curved surface 7 is provided between the main surface 2 and the chamfered surface 4; and the curvature radius R of the curved surface 7 where R≧0.013 mm and R≦0.080 mm, where the basal level T refers to a flat surface of the main surface 2 of the silicon substrate 1; point A₁ refers to the position present on the border line S of the main surface 2, which is located at the point displaced by 1 mm in the direction from the outer circumferential surface 3 to the center of the substrate parallel to the basal level T; point A₂ refers to the position present on the border line S of the main surface 2, which is located at the point displaced by 1.6 mm in the direction from point A₁ to the center of the substrate parallel to the basal level T; and point A₃ refers to the position present on the border line S of the main surface 2 between points A₁ and A₂, which is located at the highest position with respect to the basal level T.

As described in FIG. 3, the basal level T is based on a flat surface which is calculated by way of the least square method with respect to the main surface 2. More specifically, in the measurement of the basal level T, firstly, a cross-section which passes through the center of the substrate, and is vertical to the main surface 2 is defined. Then, at least two reference points are plotted on the border line S of the main surface 2 within its recorded area (inner area of the substrate across point A₂), and they are designated as R₁ to Rₙ (n represents the number of the reference points) respectively from the closest point to the center of the substrate. For example, they may be plotted at the positions: R₁=6.5 mm and R₂=8.3 mm (the distance from the center of the substrate to the point) when the outer diameter of the disk is 0.85 inch; R₁=8.3 mm and R₂=10.6 mm when the outer diameter is 1.0 inch; R₁=14.8 mm and R₂=18.8 mm when the outer diameter is 1.89 inches; R₁=23.0 mm and R₂=27.0 mm when the outer diameter is 2.5 inches.

Next, the shape of the silicon substrate 1 is profiled with respect to each of the reference points R₁ to Rₙ, for example, by using a stylus or optical surface profiler. Then, based on the results of profiling the shape of the silicon substrate 1, the equation for the line representing each reference point is calculated by way of the least squares method, in which the equation of the line minimizes the sum of the squares of errors in the measured data with respect to the equation of the line. This configured line represents a base line defining the flat surface of the main surface 2, namely basal level T. Hereinafter, letting this basal level T be zero (0), the upper region across basal level T is defined as positive (+), and the lower region across basal level T is defined as negative (−).

Next, two reference points are set on the border line S of the main surface 2 as follows. That is, point A₁ is set at the position present on the border line S of the main surface 2, which is located at the point displaced by 1 mm in the direction from the outer circumferential surface 3 to the center of the substrate parallel to the basal level T; and point A₂ set at the position present on the border line S of the main surface 2, which is located at the point displaced by 1.6 mm in the direction from point A₁ to the center of the substrate parallel to the basal level T. Then, the shape of the silicon substrate 1 is profiled between points A₁ and A₂, for example, by using a stylus or optical surface profiler. Then, based on the results of profiling the shape of the silicon substrate 1, the ski-jump value H₀, the roll-off value H₁, and the tag-off value H₂ are obtained.

The ski-jump value H₀ is a value represented by the distance between the basal level T and point A₃ in which point A₃ locates at the position present on the border line S of the main surface 2 between points A₁ and A₂, which is located at the highest position with respect to the basal level T. In addition, FIG. 3 shows the case in which the ski-jump value H₀ is a positive (+) value. In this case, the border line S of the main surface 2 shows a shape in which it elevates upward to the highest position, namely point A₃, with respect to basal level T. On the other hand, as shown in FIG. 2, the border line of the main surface 2 forms a surface-lowering (roll-off) shape between points A₁ and A₂ when the ski-jump value H₀ is H₀≦0 μm, and represents a negative (−) value.

The roll-off value H₁ is a value represented by the distance from the basal level T to point A₁. The roll off value H₁ shows the corner caving rate of the outer circumferential portion of the silicon substrate 1, and is never over 0.0 μm. On the other hand, if the value H₁ is less than −0.2 μm, then, its corner caving rate is in excess, and the flying attitude of the magnetic head tends to be unstable at the outer circumferential portion. Therefore, the roll-off value H₁ is preferably H₁≧−0.2 μm and H₁≦0.0 μm, and more preferably H₁≧−0.18 μm and H₁≦−0.08 μm.

As shown in FIG. 4, the tag-off value H₂ is a value represented by the maximum displacement of the border line S of the main surface 2 with respect to the line X between points A₁ and A₂. The tag-off value H₂ shows the roundness of the outer circumferential portion of the silicon substrate 1. The value H₂ is never less than 0 μm, but, if the value H₂ is over 0.012 μm, then, the roundness is in excess, and the flying attitude of the magnetic head tends to be unstable at the outer circumferential portion, as well as the dusts are likely to be generated from the lapping tape when the lapping tape contacts the outer circumferential portion of the silicon substrate 1. Therefore, the tag-off value H₂ is preferably H₂≧0 μm and H₂≦0.012 μm, and more preferably H₂≧0.004 μm and H₂≦0.008 μm.

With regard to the method of measuring the curvature radius R of the curved surface 7, as shown in FIG. 5, a line (broken line shown in FIG. 5) is extended from the basal level T of the above-described main surface 2, letting the position at which this extended line displaces from the curved surface 7 as the starting point A. Then, points B and C are set respectively on the border line S of the main surface 2, and on the border line S′ of the curved surface 7, which are displaced by 10 μm from the starting point A in the direction of the main surface 2 or curved surface 7. Next, the shape of the silicon substrate 1 is profiled with respect to each of points A, B, and C, for example, by using a stylus or optical surface profiler. Then, based on the surface-profiling of the silicon substrate 1, the radius of the circle O passing through these points A, B, and C is calculated, and this value is used as the curvature radius R of the curved surface 7.

In addition, a commercially available measuring apparatus (“CONTRACER CP400”, produced by MITSUTOYO CORPORATION) is used for measuring the curvature radius of the curved surface 7. The conditions set in this measuring apparatus are follows:

### <Measuring Conditions>

Velocity: 0.06 mm/s

Pitch: 0.0010 mm

Mode: X-axis fixed

If the curvature radius R of the curved surface 7 is less than 0.013 mm, then, the region between the main surface 2 and chamfered surface 4 becomes too steep, the substrate does not endure the impact, and therefore, is susceptible to cracks, chips or the like when it is handled or collides with something. On the other hand, if the curvature radius R is over 0.080 mm, the area of the main surface 2 on which the information is recorded becomes narrower. Therefore, the curvature radius R of the curved surface 7 is preferably R≧0.013 mm and R≦0.080 mm, and more preferably R≧0.030 mm and R≦0.070 mm.

In addition, in the silicon substrate 1 of the present invention, such a curved surface can be also provided between the main surface 2 and the chamfered surface 6 of the inner circumferential portion.

As described above, by processing the outer circumferential portion of the silicon substrate 1 into the above-described shape in the magnetic disk substrate of the present invention, the cracks and chips in the silicon substrate 1, which is materially fragile, can be prevented. Also, the magnetic disk silicon substrate can be produced, which can prevent the generation of dust in the production process of the magnetic disks.

### (Method of Producing Magnetic Disk Substrate)

Hereinafter, the method of producing the above-described magnetic disk substrate is explained.

As an example of the silicon substrate 1, namely the above-described magnetic disk substrate, monocrystal silicon (Si) which is used frequently in the field of semiconductor engineering can be applied. The above-described silicon substrate 1 can be produced by way of the following processes.

Specifically, in order to produce this silicon substrate 1, firstly, a monocrystal silicon ingot is produced by way of the Czochralski method. Then, this ingot is sliced in a predetermined thickness. The small-diameter silicon substrates cut from the sliced disks are subjected to a lapping process in order to improve accuracy of the shape and dimension. This lapping process is conducted in two steps by using a lapping apparatus. The obtained silicon substrate obtained generally after conducting the first step of the lapping process is relatively large to be a magnetic disk substrate, and therefore, the silicon substrate 1, which has appropriate inner- and outer-diameters, is cut from the large silicon substrate by using a laser scriber. After this, the outer and inner circumferential portions of the silicon substrate 1 are subjected to a chamfering process, and chamfered surfaces 4 between the main surfaces 2 and the outer circumferential surface 3, and chamfered surfaces 6 between the main surfaces 2 and the inner circumferential surface 5 are formed. At this point, the surface roughness of the inner and outer circumferential surfaces of the silicon substrate 1 is, for example, about 4 μm at Rₘₐₓ. Then, the silicon substrate 1 is subjected to the second lapping process, and, for example, the profile irregularity of the main surfaces 2 is made less than 1 μm, and its surface roughness is less than 6 μm at Rₘₐₓ.

Next, the surface of the silicon substrate 1 is etched with a chemical liquid, namely a mixture including fluoric acid, nitric acid, and acetic acid, and residual damage in the lapping process is removed. Then, the chamfered surfaces 4 and 6 of the silicon substrate 1 are polished and mirror-finished. Finally, the main surfaces 2 on which the magnetic recording layers are provided are polished. With regard to polishing the main surfaces 2, a first polishing step in which scratches or distortions generated in the previous processes are removed, and a second polishing step in which the surfaces are mirror-finished, are conducted. By way of the above-described processes, the magnetic disk substrate can be obtained.

In the magnetic disk substrate of the present invention, by polishing the outer circumferential surface 3 of the above-described silicon substrate 1 with a polishing brush, the above-described shape of the outer circumferential portion can be obtained.

Specifically, the plural silicon substrates 1 are arranged, for example, as a layered structure 11 as shown in FIG. 6. In this layered structure 11 of the silicon substrates 1, the plural silicon substrates 1 are layered, and spacers 12 are inserted between the silicon substrates 1.

The spacers 12 are provided in order to prevent the chamfered surfaces 4 and 6 of the inner- and outer-circumferential portions of the silicon substrates 1 from being unpolished in some parts, and in order to prevent the silicon substrates 1 from being broken when they are polished. This spacer 12 has the same shape of a disk having a central aperture as the silicon substrate 1. Also, the thickness of the space 12 is adjusted according to the diameter of the bristles of the brush used, but the diameter is, for example, about 0.1 mm to 0.3 mm. As for the material of the spacer 12, those which are softer than the silicon substrate 1 may be applied. It is preferable that those which are materially the same as the polishing pad used in the polishing process, in particular, those which are soft to such a degree that they can prevent the destruction of the silicon substrate 1 caused by the pressures from the polishing brush and the polishing pad be used. As examples of such materials, a polyurethane resin, acrylic resin, epoxy resin, or the like can be mentioned.

The diameter of the spacer 12 is arranged such that the outer circumferential surface of the spacer 12 is about 0 mm to 2 mm inside from the chamfered surface 4 of the silicon substrate 1, preferably about 0.5 mm to 2 mm inside when the spacer 12 is inserted between silicon substrates 1 forming the layered structure 11. In this case, although it varies with the thickness of the spacer 12 and the diameter of the bristles of the brush, the bristles enter the region of the main surfaces 2 of the silicon substrate 1, and then, the regions between the main surfaces 2 and chamfered surfaces 4 are polished. Thus, the regions become rounded off.

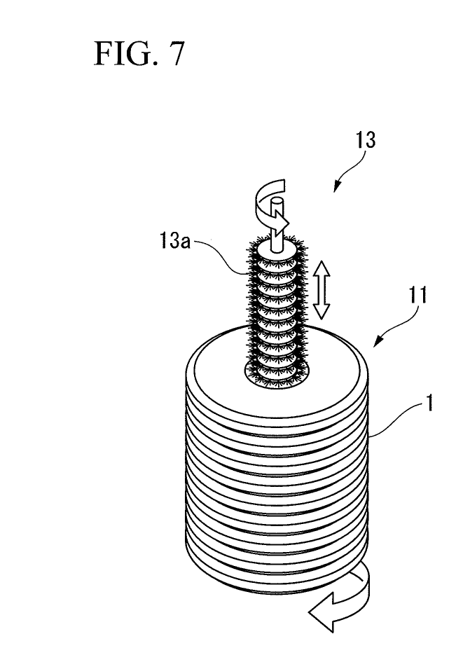

In this polishing process, as shown in FIG. 7, the inner circumferential portion of the layered structure 11 is polished with a polishing brush 13. Specifically, silicon substrates 1 and spacers 12 are layered one after the other, and a clamped layered structure 11 of the silicon substrates 1 is formed by clamping a clamping cover with jigs.

Next, the polishing brush 13 is inserted into the central aperture 11a of the layered structure 11 such that bristles 13a contact with the inner circumferential surface 5 of each silicon substrate 1. For example, as the polishing brush 13, a brush made by helically binding polyamide-based fibers which have a diameter of about 0.05 mm to 0.3 mm, and is about 1 mm to 10 mm long can be used. Then, an appropriate amount of the polishing solution is applied to the polishing brush 13 by way of dripping, the inner circumferential surface 5 of the silicon substrate 1 is polished with the polishing brush 13, in which the polishing brush 13 is shifted up and down against the layered structure 11 while they are rotated in the opposite direction from one another. In addition, the rotating rate of the layered structure 11 is, for example, about 60 rpm, and the rotating rate of the polishing brush 13 is, for example, about 1000 rpm to 3000 rpm.

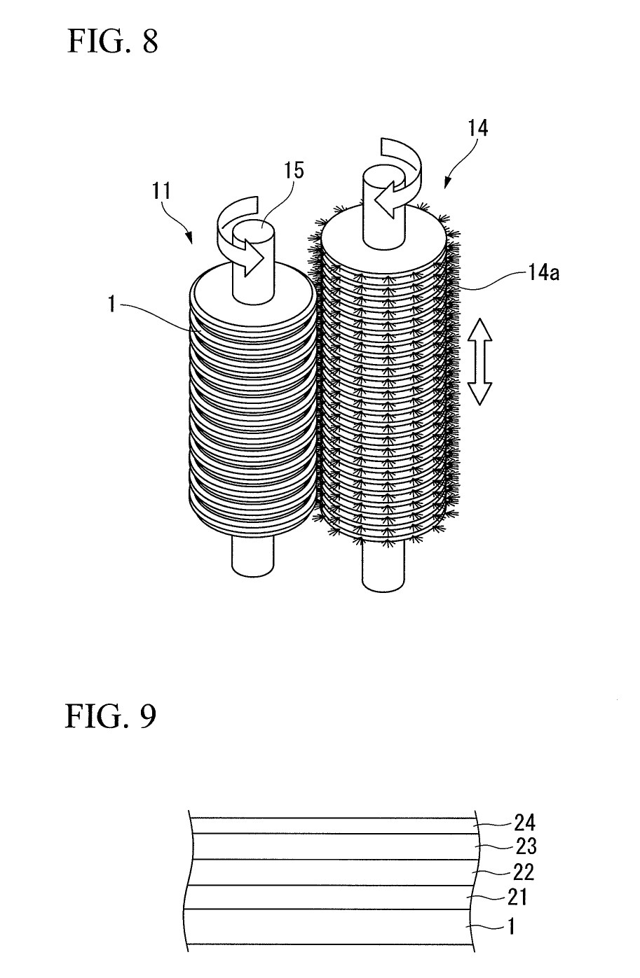

Also, as shown in FIG. 8, the outer circumferential portion of the layered structure 11 is polished with a polishing brush 14. Specifically, a shaft 15 is inserted into the central aperture 11a of the layered structure 11, and the polishing brush 14 is pushed against the surface of the outer circumferential portion of the layered structure 11 such that bristles 14a contact with the outer circumferential surface 3 of each silicon substrate 1. For example, as a polishing brush 14, a cylindrical brush having a diameter of about 200 mm to 500 mm made by helically binding polyamide-based fibers which have a diameter of about 0.05 mm to 0.3 mm, and is about 1 mm to 10 mm long can be used. Then, an appropriate amount of the polishing solution is applied to the polishing brush 14 by way of dripping, the outer circumferential surface 3 of the silicon substrate 1 is polished with the polishing brush 14, in which the polishing brush 14 is shifted up and down against the layered structure 11 while they are rotated in the opposite direction from one another. In addition, the rotating rate of the layered structure 11 is, for example, about 60 rpm, and the rotating rate of the polishing brush 14 is, for example, about 700 rpm to 1000 rpm.

After the above-described polishing process with the brush, the main surfaces 2 of the silicon substrate 1 are washed with water, and are subjected to a first polishing step. This first polishing step mainly aims to remove scratches and distortion remaining from the previously-conducted processes. In the first polishing step, a polishing apparatus for general use can be used, and, as an example of a polishing solution, colloidal silica mixed with water can be used. In the first polishing step, the main surface 2 of the silicon substrate 1 can be polished, for example, under the following conditions. The load is about 100 gf/cm² (0.98 N/cm² (relative pressure)); the rotating rate of the down press platen is about 40 rpm; rotating rate of the upper press platen is about 35 rpm; the rotating rate of the sun gear is about 14 rpm; and the rotating rate of the internal gear is about 29 rpm.

Next, the silicon substrates are washed with water after the first polishing step, and subjected to a second polishing step (finishing polishing) to be finished. In this second polishing step, for example, a liquid mixture of colloidal silica and water can be used. In the second polishing step, the main surface 2 of the silicon substrate 1 can be polished, for example, under the following conditions. The load is about 100 gf/cm² (0.98 N/cm² (relative pressure)); the rotating rate of the down press platen is about 40 rpm; the rotating rate of the upper press platen is about 35 rpm; the rotating rate of the sun gear is about 14 rpm; and the rotating rate of the internal gear is about 29 rpm.

Next, after the second polishing, the silicon substrate 1 is subjected to ultrasonic cleaning, for example, by soaking in each of washing tanks filled with a neutral detergent; pure water; a mixture of pure water and IPA (isopropyl alcohol); and IPA (steam drying) in order.

By conducting the above-described processes, the above-described silicon substrate 1 can be obtained, in which the ski-jump value H₀ is H₀≦0 μm; the roll-off value H₁ is H₁≧−0.2 μm and H₁≦0.0 μm; the tag-off value H₂ is H₂≧0 μm and H₂≦0.012 μm; the curved surfaces 7 are provided between the main surfaces 2 and the chamfered surfaces 4; and the curvature radius R of the curved surfaces 7 is R≧0.013 mm and R≦0.080 mm.

In the present invention, methods other than the above-described method of polishing the outer circumferential surface of the silicon substrate 1 by using a polishing brush can be used as long as they can achieve the above-described shape of the outer circumferential portion of the silicon substrate 1.

### (Magnetic Disk)

Hereinafter, a magnetic disk (magnetic recording medium) using the above-described magnetic disk substrate is explained.

The magnetic disk of the present invention includes at least a magnetic recording layer formed on the above-described disk substrate. That is, the magnetic disk of the present invention uses the above silicon substrate 1 having the above-described shape of the outer circumferential portion, and there is no limitation to the structure of each layer such as the primary coat, the magnetic recording layer, the protective layer, the lubricant layer which are successively layered on the silicon substrate 1; the method of forming each of the layers; or the like as long as they do not substantially hamper the effects brought up by processing the outer circumferential portion of this silicon substrate 1 to the above-described shape.

For example, with regard to a magnetic disk shown in FIG. 9, a primary coat 21 of CrMo, magnetic recording layer 22 of CoCrPtTa, and protective layer 23 of hydrogenated carbon are successively layered on both sides of the above-described silicon substrate 1 by using a inline-type sputtering apparatus or the like, a liquid-lubricant layer 24 of perfluoropolyether is further formed thereon by way of the dipping method, and this is obtained by subjecting the silicon substrate to a burnishing treatment using a lapping tape.

### INDUSTRIAL APPLICABILITY

In the magnetic disk using the above-described silicon substrate 1, the present invention can prevent the materially fragile silicon substrate 1 from cracking or chipping, as well as preventing the generation of the dusts in the process of producing the magnetic disk. That is, the present invention can prevent the generation of dust from the lapping tape when the lapping tape contacts with the outer circumferential portion of the silicon substrate 1 in the above-described burnishing treatment, and also, and the present invention can prevent the particles from adhering to the surface of the magnetic disk. Accordingly, the yield of the production of the magnetic disks can be improved; the generations of errors, head-crashing or the like during the periods of reading or writing can be prevented; and the low flying height of the magnetic head can be achieved. As a result, the magnetic disk of the present invention can be compatible with the required higher recording density. Therefore, the silicon substrate and the magnetic disk of the present invention are highly applicable to various fields of technology such as the IT industry.

1. A magnetic disk substrate which uses a silicon substrate, wherein
chamfered surfaces are provided between main surfaces and an outer circumferential surface of the silicon substrate;
a ski-jump value H₀ where H₀≦0 μm, representing a distance from a basal level to a point A₃;
a roll-off value H₁ where H₁≧−0.2 μm and H₁≦0.0 μm, representing a distance from the basal level to a point A₁;
a tag-off value H₂ where H₂≧0 μm and H₂≦0.012 μm, representing a maximum displacement of a border line of the main surface with respect to a line A₁ to A₂;
curved surfaces are provided between the main surfaces and the chamfered surfaces; and
a curvature radius R of the curved surface where R≧0.013 mm and R≦0.080 mm, where
the basal level refers to a flat surface of the main surface; the point A₁ refers to a position present on the border line of the main surface, which is located at a point displaced by 1 mm in the direction from the outer circumferential surface to a center of the substrate parallel to the basal level; the point A₂ refers to a position present on the border line of the main surface, which is located at a point displaced by 1.6 mm in the direction from the point A₁ to the center of the substrate parallel to the basal level; and the point A₃ refers to a position present on the border line of the main surface between the points A₁ and A₂, which is located at a highest position with respect to the basal level.

2. The magnetic disk substrate according to claim 1, wherein the roll-off value H₁ is H₁≧−0.18 μm and H₁≦−0.08 μm, the tag-off value H₂ is H₂≧0.004 μm and H₂≦0.008 μm, and the curvature radius R is R≧0.030 mm and R≦0.070 mm.

3. A magnetic disk which uses the magnetic disk substrate according to claim 1.

4. A magnetic disk which uses the magnetic disk substrate according to claim 2.
